(19) United States
(12) Patent Application Publication
(10) Pub. No.: US 2024/0242490 A1
(43) Pub. Date: Jul. 18, 2024

(54) COMPONENT CLASSIFICATION DEVICE, METHOD FOR CLASSIFYING COMPONENTS, AND METHOD FOR TRAINING A COMPONENT CLASSIFICATION DEVICE

(71) Applicant: MTU Aero Engines AG, Muenchen (DE)

(72) Inventors: Fabian Steinhart, Munich (DE); Rolf Burmeister, Rodewald (DE); Ali-Reza Rahnama, Hannover (DE); Steffen Claus, Wildau (DE); Timo Pohl, Neustadt (DE); Semih Dinc, Berlin (DE); Nico Koppold, Berlin (DE); Dominik Kugler, Berlin (DE); Sebastian Plamauer, Munich (DE); Robin Dehde, Munich (DE); Verena Lang, Munich (DE); Banjamin Braun, Munich (DE)

(21) Appl. No.: 18/559,274

(22) PCT Filed: Apr. 21, 2022
(86) PCT No.: PCT/DE2022/100303

§ 371 Date: Nov. 6, 2023

(30) Foreign Application Priority Data
May 10, 2021 (DE) 10 2021 112 068.3
Sep. 14, 2021 (DE) 10 2021 123 761.0

(51) Int. Cl. G06V 10/776; G06V 10/40; G06V 10/764; G06V 10/77; G06V 10/82

(52) U.S. Cl. CPC G06V 10/776; G06V 10/40; G06V 10/764; G06V 10/7715; G06V 10/82

(57) ABSTRACT

A component classification device for classifying components into predefined component classes, including a camera device that is configured to generate image data of a component to be classified, and a weighing device that is configured to generate weight data of the component to be classified. The component classification device includes an evaluation device that is configured to generate predefined image features from the image data according to a predefined image feature extraction method, and to supply the image data to a pretrained first neural network, and to generate bottleneck features of the image data from a predefined bottleneck layer of the first neural network. The component classification device includes a classification unit that is configured to assign at least one of multiple predetermined component classes, which describe predetermined component groups and/or components, to the component according to a predetermined classification method, based on the weight data, the image features, and the bottleneck features.

The present invention relates to a component classification device, a method for classifying components, and a method for training a component classification device.

### BACKGROUND

When disassembling an apparatus such as an aircraft turbine, for example, there are many components of the aircraft turbine. To allow categorizing the components in question, it is customary to apply character recognition methods which allow detection of a part number or serial number provided at the component. However, this results in the problem that an automated text recognition is possible only to a limited extent on account of wear or soiling, or due to the metallic properties. Another option for simplifying the categorization of components is to apply conventional image processing and/or machine vision methods. However, due to the large number of classes of the components and relatively small deviations between the components, machine vision methods are inadequate for enabling a reliable categorization of the components.

A 3D object-based mechanical parts selection by 2D image processing is provided in U.S. Pat. No. 9,934,563 B2. The method provides that automatically rotated two-dimensional images of target objects to be recognized, for example machine parts, are generated from a number of two-dimensional images of a target object. A three-dimensional image of the target object is generated from the rotated two-dimensional images. It is thus possible to ensure an image recognition, even with insufficient illumination, by carrying out the image recognition process for multiple images and learning the successful recognition results.

A method and a component classification device for identifying components are provided in EP 1 942 443 A1. The method provides that individual features of a component that have been coincidentally formed during its manufacture and/or machining are ascertained in defined areas, and stored as a set of features for this component. It is provided that for identifying the component, it is examined in the defined areas for the presence of the individual features, and the ascertained set of features of the component is compared in each case to the stored sets of features in order to identify the component based on being identical or highly similar.

A method and a component classification device for quality testing of molded parts are provided in DE 195 27 147 A1. The component classification device for carrying out the quality testing includes an assessment device for assessing the quality of an object by comparing at least one actual dimensional parameter of the actual dimensional shape of the object to a corresponding desired parameter of the desired shape. The component classification device includes an evaluation unit that is configured to determine a density of the object from a weight that is provided by a weighing device, and a volume of a setpoint dimensional shape.

A method is described in the dissertation titled “Automated detection and extraction of electrical scrap components using image processing methods and machine learning methods with regard to tantalum recycling,” by Johannes Rucker, University of GieBen, in which printed circuit boards are measured by a recognition system using imaging sensors, and the data thus obtained are evaluated using machine learning and image processing methods. In the process, the data are segmented and subsequently classified.

In the publication by SUN, Weichen, et al., “Small sample parts recognition and localization from unfocused images in precision assembly systems using relative entropy,” Precision Engineering, 2021, Vol. 68, pp. 206-217, a component recognition and localization method is described which is based on relative entropy and which may be applied to small samples. It is provided that a template image is generated based on contours of a component and subdivided into multiple regions. An intensity distribution of the regions was recorded to generate template features.

In the publication by JAIN, Tushar; MEENU, Dr. HK, “Machine Vision System for Industrial Parts Recognition,” a machine vision method for recognizing industrial components is provided.

### SUMMARY OF THE INVENTION

The object of the present invention is to enable a reliable, automated classification of components.

The object is achieved according to the present invention by a component classification device, a method for classifying components, and a method for training a component classification device. Advantageous embodiments together with useful refinements of the present invention are stated herein; advantageous embodiments of each aspect of the present invention are to be regarded as advantageous embodiments of the respective other aspects of the present invention.

A first aspect of the present invention relates to a component classification device that is configured to classify components in predetermined component classes. The component classification device includes a camera device that is configured to generate image data of the component to be classified. In other words, the camera device of the component classification device is provided for recording image data of the component, which include images of the component to be classified. The camera device may include one or multiple cameras that are configured to record images of the component in the visible spectrum and/or in the infrared spectrum and/or in the ultraviolet spectrum, from particular perspectives. The component classification device includes a weighing device that is configured to generate weight data of the component to be classified. In other words, the weighing device is configured to detect a weight of the component and to provide the weight in the weight data.

The component classification device includes an evaluation device that is configured to generate predetermined image features from the image data according to a predetermined image feature extraction method. The evaluation device may include a processor and/or microcontroller via which the predetermined image feature extraction methods may be carried out. The predetermined image feature extraction methods may include machine vision methods and/or predetermined image processing steps. It may be provided that the image features may include edge contours, rounded areas, or dimensions such as lengths or surface areas of the component, which are extracted from the image data with the aid of the image feature extraction method.

The evaluation device is also configured to supply the image data to a pretrained first neural network and to generate predetermined bottleneck features of the image data from a bottleneck layer of the first neural network. In other words, the evaluation device is configured to evaluate the image data using the first neural network, and to extract the predetermined bottleneck features from the predetermined bottleneck layer of the first neural network. The first neural network may in particular be a pretrained neural network. It may be a pretrained convolutional neural network (CNN), for example, such as the VGG16. In particular, transfer learning may be applied in this way. In the transfer learning, a neural network that is trained on a much larger data set is used as the basis. This is advantageous when a data set of image data for components to be recognized and/or component groups to be recognized is made up of only a few hundred images, which would not be sufficient for training a neural network. The first neural network may include multiple layers. The last layers are then clipped from this first neural network. A validated hypothesis is that in particular the first layers of a neural network are relevant for the feature extraction, for example edge filtering and corner filtering. The last remaining layer of the pretrained first neural network contains a high-dimensional, in particular 512-dimensional or greater than 512-dimensional, representation of abstract pieces of information concerning the underlying image. This layer is the mentioned bottleneck layer. The bottleneck features include the described abstract pieces of information of the image data. In the discussion here and below, an artificial neural network may be understood as software code that is stored on a computer-readable memory medium, and that represents one or multiple networked artificial neurons or that may simulate their function. The software code may also contain multiple software code components that may have different functions, for example. In particular, an artificial neural network may implement a nonlinear model or a nonlinear algorithm that maps an input onto an output, the input being provided by an input feature vector or an input sequence, and it being possible for the output to contain, for example, a category that is output for a classification task, one or multiple predicted values, or a predicted sequence.

The bottleneck features may be output features of the bottleneck layer of the first neural network. The advantages and the nature of the bottleneck layer and of the bottleneck features are known from the technical literature in the field of neural networks. The bottleneck layer may be a middle or inner layer of the first neural network, and may be situated between two layers of the first neural network. The bottleneck layer may differ from other layers of the first neural network by having a smaller number of neurons and/or transferred features. For this reason, the output features of the bottleneck layer, the stated bottleneck features, may have a smaller dimensionality than output features of the other layers of the first neural network. The bottleneck features may thus enable a low-dimensional representation of the input data, for example the image data, that are supplied to the first neural network. In the present invention it may also be provided that output features of an arbitrary layer of the first neural network are understood as bottleneck features. This may be provided, for example, when a predetermined layer of the first neural network outputs output features that are suitable for a classification of the component. Bottleneck features may be based, for example, on image features, for example edges, textures, or homogeneous surface areas. In contrast, the bottleneck features do not yet represent a final classification result.

The component classification device also includes a classification unit that is configured to assign to the component, according to a predetermined classification method, the image features and the bottleneck features of at least one of multiple predetermined component classes that describe predetermined component groups and/or components, based on the weight data. In other words, the classification unit is configured to ascertain which of the predetermined component classes may be assigned to the component. The component classes may include different taxonomic levels, and include component groups, component subgroups, or specific component recognition numbers, for example. It may be provided, for example, that component groups such as screws, nuts, or metal sheets or specific components are described by the component classes.

In the discussion here and below, the classification method may be understood as a computer algorithm that is capable of identifying the component to be classified in the image features, the bottleneck features, and the weight data, and assigning an appropriate component class to the component to be classified, it being possible to select the component classes from a predefined set of component classes. The assignment of a component class to the component to be classified may be understood in such a way that an appropriate confidence value or a probability that the component to be classified belongs to the component class in question is provided. For example, the algorithm may provide such a confidence value or a probability for a component to be classified for each of the component classes. The assignment of the component class may involve, for example, the selection or provision of the component class having the largest confidence value or the highest probability. The classification method and/or the classification unit may also be referred to as classifiers.

The present invention results in the advantage that the classification device is configured to generate multiple input features for classifying the component, which include weight features, image features, and the bottleneck features. This results in the advantage that a more reliable categorization of components is possible than is the case, for example, for categorizations based solely on image features.

The present invention also encompasses refinements which result in further advantages.

One refinement of the present invention provides that the predetermined classification method includes an assignment by a second neural network. In other words, for this purpose it is provided that the classification unit is configured to carry out the classification method, the classification method including an assignment of the component to one of the predetermined component groups with the aid of a second neural network. It is provided, for example, that the bottleneck features, the image features, and the weight features are provided to a neural network as input variables, and the assignment to possible predetermined component classes and/or components is carried out by the second neural network. It may be provided, for example, that the layers ignored by the first neural network may be replaced by new layers of the second neural network. The bottleneck features, which are generated by the first neural network, the image features, and the weight data, may be supplied to these layers. The layers of the second neural network may then be trained on an actual data set for categorizing the components. In this way, the second neural network may learn, for example from the image information already preprocessed by the first neural network, the bottleneck features, to predict the component classes of components to be categorized. Compared to an image that is made up of several hundred thousand or millions of pixels, this preprocessing greatly reduces the complexity, and is thus more resource-saving by several orders of magnitude compared to naive approaches. The training of the second neural network may thus be carried out on a terminal such as a laptop. This may be advantageous in particular for a training of the classification device in order to save on fairly complicated hardware.

One refinement of the present invention provides that the classification unit is configured to ascertain in the predetermined classification method a particular probability value of the at least one component class that describes with what probability the component is assigned to the component class. It may be provided, for example, that an assignment of the component takes place in a last layer of the second neural network. For at least some of the predetermined component classes, the last layer may output the particular probability value for the probability with which the component of the particular component class is assigned by the last layer of the second neural network.

One refinement of the present invention provides that the component classification device includes a user interface, the component classification device being configured to output the at least one component class to the user interface. The user interface may include, for example, a screen with an input device and/or a connection for communicating with a processing unit.

One refinement of the present invention provides that the component classification device is configured to receive at the user interface predetermined assessment data with regard to the component class or a manually specified component class, the component classification device being configured to adapt the second neural network, as a function of the assessment data, with regard to the ascertained component class and/or the specified manual component class. In other words, the component classification device is configured to receive the assessment data that assess the output accuracy of the component class. It may be possible, for example, for the user interface to include buttons or a touchscreen which allow the user to enter an assessment of the result of the classification with the aid of user inputs. It may be provided, for example, that the user interface allows a user to assess an output result as correct or incorrect. It may also be possible for a user to assess an accuracy of the result and/or make corrections with the aid of the user interface. The classification device is configured to apply the assessment data or the manually specified component class as an input value for training the second neural network. In other words, it is provided that the second neural network is trained with incorporation of the assessment data and/or the manually specified component class. The user interface may thus fulfill two objectives. On the one hand, it facilitates the validation of the results by a user for the input of the assessment data into the component classification device, and on the other hand it allows generation of training data. Accordingly, the component classification device may be retrained by the user, for example automatically or manually initiated. For example, a training of the second neural network may be initiated. During the training it may be checked, by regression testing, for example, whether the new model is at least as good as the previous version.

One refinement of the present invention provides that the component classification device is configured to increase a data volume of the image data according to a predetermined data augmentation method. In other words, the component classification device is configured to supplement the detected image data with derived image data that are generated from the detected image data. In other words, the component classification device is configured to apply the predetermined data augmentation method, which may also be referred to as data extension, to the detected image data in order to increase a data volume of the image data. The component classification device is configured, for example, to supplement the detected image data with the derived image data, the derived image data being derived from the detected image data. It may be provided, for example, that the component classification device is configured to rotate, to mirror, to partially conceal, to distort, or to change in a similar known manner images of the detected image data, using a predetermined transformation method, in order to generate the image data that are derived from the detected image data. The component classification device may be configured to supplement the image data with the derived image data in order to increase the data volume of the image data. This results in the advantage that a larger data volume may be provided for a detection of the component or a training of the second neural network of the component classification device.

One refinement of the present invention provides that the component classification device is configured to generate the image features using a machine vision method. In other words, the image classification data are generated by the image processing methods and/or machine vision methods. It may be provided, for example, that edges, radii, dimensions, and/or orientations, for example, may be extracted as the image features by use of image processing methods and/or machine vision methods. The predetermined image feature extraction method may encompass, for example, a Hough transform, a segmentation, a radon transform, a silhouette cutting method, and/or photogrammetric method steps.

One refinement of the present invention provides that the component classification device is configured to detect edges and/or radii of curvature of the component as image features. In other words, it is provided that the image features may include edge lengths, radii of curvature, or other geometric variables. This results in the advantage, for example, that detected dimensions may be used to ascertain the component class.

One refinement of the present invention provides that the predetermined classification method includes a random forest method. In other words, it is provided that at least one method step of the predetermined classification method includes a classification that takes place via multiple uncorrelated decision trees which may have been developed during a training of the classification method. The refinement results in the advantage that a classifier may be used which is suited in particular for a large number of component classes.

One refinement of the present invention provides that the second neural network has a feedforward neural network architecture. In other words, the second neural network is designed as a feedforward neural network. This means that pieces of information are passed on between layers of the second neural network in only one direction, the processing direction. The layers of the second neural network thus include no recurrent or back-coupled connections for which pieces of information are relayed between the layers, opposite the processing direction.

A second aspect of the present invention relates to a method for classifying a component by use of a component classification device. It is provided that image data of a component to be classified are generated by a camera device. A weighing device generates weight data of the component to be identified. Predetermined image features from the image data are generated by an evaluation device according to a predetermined image feature extraction method, and the image data are supplied to a pretrained first neural network, and bottleneck features of the image data are generated from a predetermined bottleneck layer of the first neural network. It is provided that a classification unit assigns to the component at least one component class regarding the component, based on the weight data, the image features, and the bottleneck features from multiple predetermined component classes, according to a predetermined classification method.

Further features and advantages thereof are apparent from the descriptions of the first aspect of the present invention.

A third aspect of the present invention relates to a method for training a component classification device. It is provided that in the method a camera device generates image data of a component to be classified, and a weighing device generates weight data of the component to be classified. An evaluation device generates predetermined image features from the image data according to a predetermined image feature extraction method. The image data are supplied to a pretrained first neural network by the evaluation device, and bottleneck features of the image data are generated from a bottleneck layer of the first neural network. A classification unit assigns to the component at least one predefined component class, based on the weight data, the image features, and the bottleneck features, according to a predetermined classification method. Assessment data and/or a manually specified component class are/is received by a user interface of the component classification device, and the predetermined classification method is adapted according to a predetermined adaptation method.

Further features and advantages thereof are apparent from the descriptions of the first and second aspects of the present invention.

### BRIEF DESCRIPTION OF THE DRAWINGS

Further features of the present invention result from the claims, the figures, and the description of the figures. The features and feature combinations mentioned above in the description as well as the features and feature combinations mentioned below in the description of the figures and/or only shown in the figures may be used not only in the particular stated combination, but also in other combinations without departing from the scope of the present invention. Thus, embodiments of the present invention not explicitly shown or explained in the figures, but which follow and are producible from the described embodiments via separate feature combinations, are thus regarded as encompassed and disclosed by the present invention. In addition, embodiments and feature combinations which thus do not include all features of an originally formulated independent claim are regarded as disclosed. Furthermore, embodiments and feature combinations, in particular resulting from the embodiments discussed above, which go beyond or deviate from the feature combinations described in the back-references of the claims are regarded as disclosed. In the figures:

FIG. 1 shows a schematic illustration of a component classification device;

FIG. 2 shows a schematic illustration of a method for classifying a component;

FIG. 3 shows a schematic illustration of a method for classification of a component;

FIG. 4 shows a schematic illustration of a neural network; and

FIG. 5 shows a schematic illustration of images of the image data.

### DETAILED DESCRIPTION

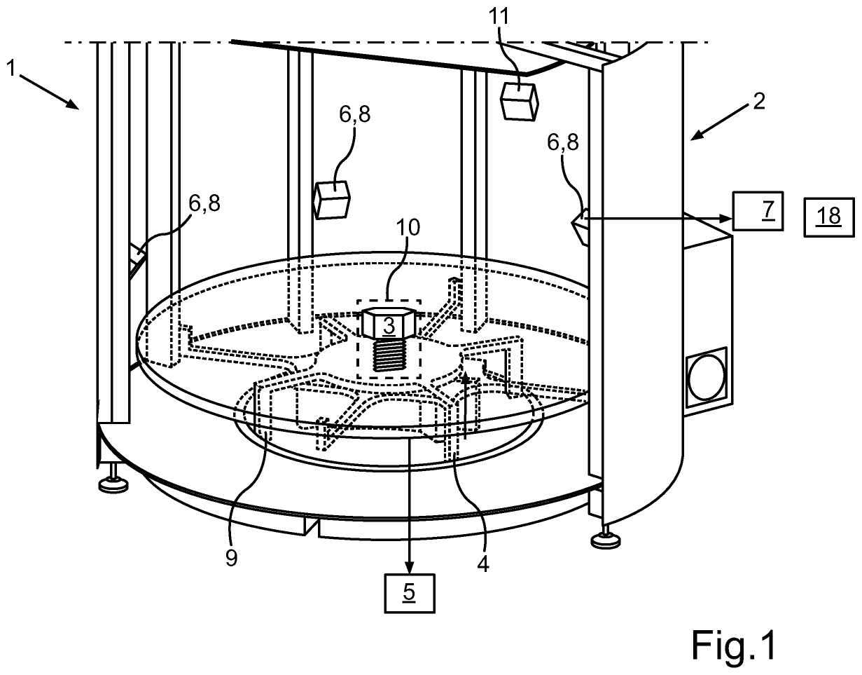

FIG. 1 shows a schematic illustration of a component classification device. Component classification device 1 may include a housing 2 in which component 3 to be classified is to be situated. In housing 2, component classification device 1 may include a weighing device 4 that may be configured to detect weight data 5 of component 3. Component classification device 1 may also include a camera device 6 that may be configured to generate image data 7 of component 3. Image data 7 may include images which may be recorded by cameras 8 of camera device 6 from different perspectives of component 3. To allow comparable image data 7 and weight data 5 of component 3 to be generated, it may be necessary to ensure constant conditions for detecting weight data 5 and image data 7. For this purpose, a storage surface 9 may be provided on which component 3 is to be situated at a predetermined position 10, for example. An accurate and consistent detection of weight data 5 may be made possible in this way. Cameras 8 of camera device 6 may be situated at different positions within housing 2 and aligned with predetermined position 10 for storing component 3. It may thus be possible for the component to be detected from different angles. To enable uniform illumination of component 3 during various classification methods, component classification device 1 may include a lighting device 11 that may illuminate component 3 in housing 2. By providing housing 2 and lighting device 11, it may be ensured that light conditions or light tones may be constant for different detections. Component classification device 1 may include an evaluation device 12 which may be configured to receive image data 7 and generate predetermined image features 13 from image data 7 according to a predetermined image feature extraction method. Predetermined image features 13 may include, for example, edge contours and/or lengths, rounded areas, radii of curvature, surface dimensions, coordinates of boreholes, or other detectable features. Image features 13 may be extracted from the image data via machine vision and/or conventional image processing. The evaluation device is also configured to supply image data 12 to a first pretrained neural network. First neural network 23 may be trained on image data of different components or other objects, which do not have to be component 3. It may be provided that first neural network 23 has been trained on an image data set that includes objects whose number and variations may be greater than those of components 3 to be detected. However, it is also possible to transfer the features, learned on the image data, to the components to be detected by extracting so-called bottleneck features 14 from a predetermined bottleneck layer 26 of first neural network 23. Component classification device 1 may include a classification unit 15 that may be configured to receive image features 13, bottleneck features 14, and weight data 5. Classification unit 15 may supply the received features to a predetermined classification method in order to classify component 3 based on weight data 5, image features 13, and bottleneck features 14 according to the predetermined classification method. The classification method may include the second neural network, for example, the described features being providable to the second neural network. The second neural network may be provided for assigning at least one of multiple component classes 16 to component 3. Component classes 16 may be predetermined, and describe particular component class groups, component class subgroups, or specific components. The second neural network may revert to the training data of first neural network 23 to enable a classification of component 3. It is provided that the second neural network is trained on components 3 which it is to subsequently categorize. Classification unit 15 may be configured to assign to ascertained component classes 16 particular probabilities 17 which indicate the probability with which component 3 is to be assigned to particular component classes 16.

Component classification device 1 may include a user interface 18 that is configured to output ascertained component classes 16 and probability values 17 to a user of component classification device 1. User interface 18 may include a touchscreen, for example. User interface 18 may be configured to detect predetermined user inputs and/or predetermined assessment data or to receive manually specified component classes 16 of component 3. It may thus be possible for a user to replace assigned component class 16 with a manually specified category if component 3 has been misclassified by component classification device 1. It may also be provided that by use of assessment data 19 it may be assessed whether a classification is incorrect or correct. Received assessment data 19 may be supplied to evaluation device 12 and/or to classification unit 15. Classification unit 15 may train the second neural network based on assessment data 19. It is thus possible for further components 3 to be added for the detection and/or for the accuracy of the second neural network to be increased.

Component classification device 1 may include nine cameras 8, for example, which may be situated in housing 2. Cameras 8 may be provided for generating image data 7. Weighing device 4, as an additional sensor system, is used to determine the weight of particular component 3. The component to be recognized is placed on the tray in the box, and is subsequently recognized via geometry and weight comparisons. The process time of the recognition is approximately 1 second. A cooling system for ensuring temperature control of the processor is installed outside the box. The playback of the recognized part number takes place on a separate screen including a user interface, which is user interface 18. In this interface, component classification device 1 may display suggestions for possible part numbers and/or component classes 16 with a percentage probability of success as probability values 17.

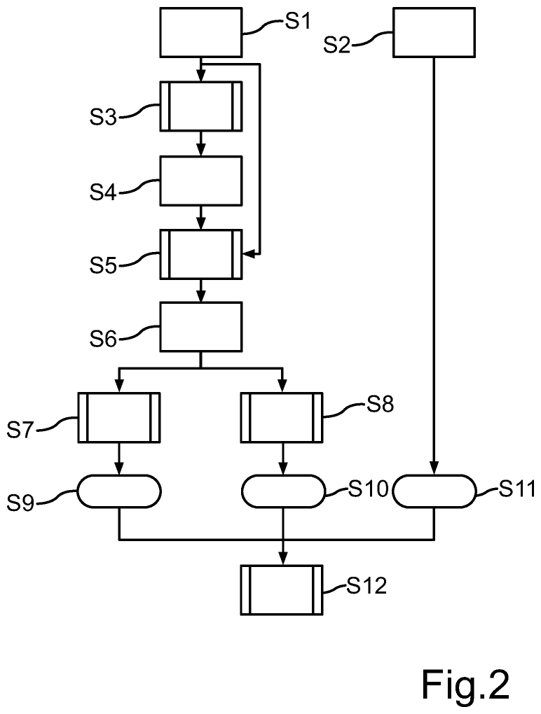

FIG. 2 shows a schematic illustration of a method for classifying a component 3. It may be provided that an image recording S1 for generating image data 7 and a weight measurement S2 for generating weight data 5 are carried out at the start of the classification method. It may be provided that image data 7 generated during image recording S1 are transformed with the aid of a predetermined data augmentation method S3 in order to generate transformed image data 7. The data augmentation method may determine predetermined transformations, which may include, for example, filters, rotations, mirrorings, or concealments of individual images 20. In this way, images 20 are varied, and the number of images 20 provided is thus increased. Additionally generated image data 7 may be added to image data 7 in a step S4. It may be provided that image data 7 are transformed in a step S5 in order to minimize images 20 to an area that is tailored to component 3. In other words, it may be provided that in the individual images it is detected in which area component 3 to be detected is present. Areas in which component 3 is not present may be separated during method step S6, so that a data volume of images 20 may be minimized. Image data 7 may be evaluated in two subsequent method steps S7 and S8 in order to extract (S9) bottleneck features 14 and recognize (S10) image features 13. For providing bottleneck features 14, image data 7 may be supplied to a pretrained first neural network 23 in method step S7. In a predetermined bottleneck layer 26 of first neural network 24, the features provided in this layer may be extracted as bottleneck features 14. In addition, an image feature of extraction method S8 may be executed, which may extract predetermined image features 13 from image data 7. Predetermined image features 13 may include, for example, positions or lengths of edges, rounded areas, or boreholes. In a method step S12, image features 13, bottleneck features 14, and weight data 5 may be transferred to a classifier in classification unit 15, which may then assign at least one of multiple predetermined component classes 16 to component 3.

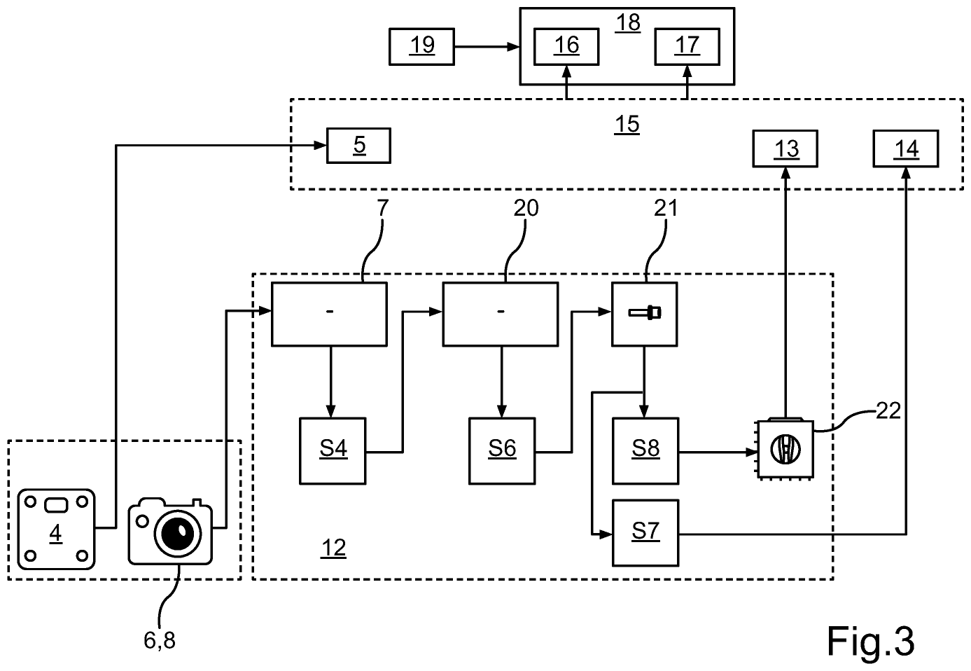

FIG. 3 shows a schematic illustration of a method for classification of a component. Method steps and examples of processed image data 7 are shown. Weight data 5 may be provided by weighing device 4. Image data 7 may be provided by camera device 6. Image data 7 may be present as raw data. It may be provided that image data 7 are processed in predetermined augmentation method S4 in order to generate further image data based on the original image data. Transformed images 20 may be generated which may be supplied to the image data set. Images 20 may be cropped in method step S6 in order to pass on only a relevant area of the image. A trimmed image 21 is ultimately generated. Trimmed image 21 may be supplied to method S8, which may recognize and extract the predetermined image features. The image data may also be supplied to first neural network (S7) to enable an extraction of the bottleneck features from a predetermined bottleneck layer.

Steps S6 through S8 may be regarded as preprocessing, and describe how a recorded image 20 of image data 7 may be processed so that image features 13 and bottleneck features 14 of classification unit 15 may be provided.

For example, nine images as image data 7, and weight data 5 may be simultaneously recorded from component 3. The predetermined augmentation method may be utilized to obtain more images of component 3. With the aid of the data augmentation, image data 7 that are present may be extended with new images by randomly generating the new images by transformations of detected images 20. For example, an image 21 may be newly generated by rotation, mirroring, or shifting. The model thus obtains new image data for a training of the classification method, but no two images are completely identical. In the next step, component 3 is recognized on image 30 based on a bounding box detection, and is trimmed to form an image 21.

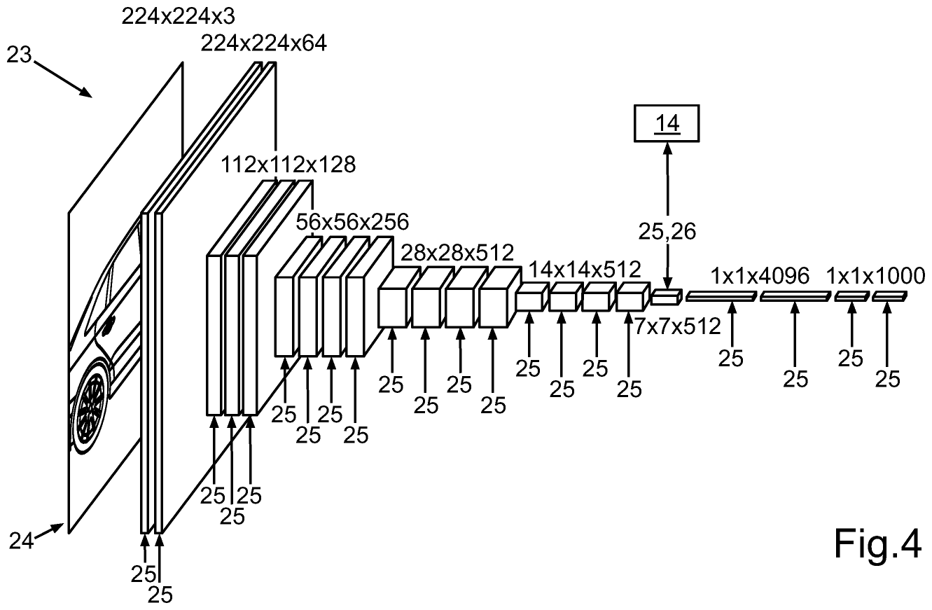

FIG. 4 shows one possible design of the first neural network. First neural network 23 may be provided to provide the bottleneck features. The image data or a cropped image may now be supplied to a pretrained convolutional neural network (CNN) (first neural network) and to an OpenCV. The pretrained CNN may be VGG16, which is pretrained on the ImageNet data set and may receive images having a size of 224×224 as input data. The trimmed image 24 may thus be scaled to the same size, and may then be transferred to the VGG16 architecture. The first neural network may include multiple layers 25, also known as a convolution block. Global average pooling may be applied after a last convolution block, which may be bottleneck layer 26. The bottleneck features are obtained therefrom as output. For new samples, the learned representations are used to extract the features of interest and transfer them into the new classifier. A total of 512 individual elements of the bottleneck features are extracted and supplied to the classifier (classification method).

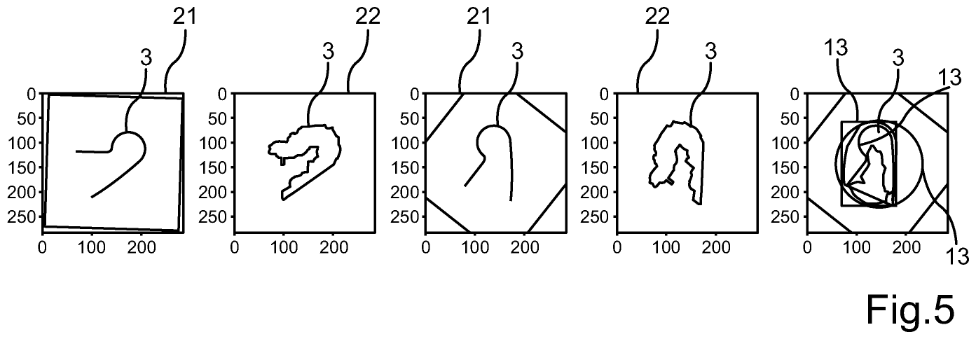

FIG. 5 shows a schematic illustration of images of the image data. Some image features of the image data, including width and height in pixels, surface area of the convex shell, and more may be extracted via the mask of the component. A total of 19 extracted features as image features may be obtained from the OpenCV and likewise transferred to the classifier classification method. In addition, the classifier obtains the information concerning the weight of the component. Images 21 may be rotated to form particular images 22, and masked so that the image features such as lengths or radii may then be removed from same.

Components may be classified based on their weight data, their image features, and their bottleneck features, i.e., assigned to a predicted class. For example, two different classifiers may be trained as a classification method. The classification method may include a random forest method and/or a dense layer (feedforward neural net) as a second neural network. Both the training time and the classification time may play a role in selecting the classification method. The training time describes the amount of time the algorithm needs to learn relationships between properties and component classes. The training time is determined by the method and the quantity of data utilized. In contrast, the classification time is defined as the amount of time the algorithm needs to carry out a classification, based on the properties. The classification time is a function of the method and the number of properties.

In order for component detection device 1 to start to recognize components, a training database, which is to be developed beforehand, is necessary. The smaller the solution space from which component detection device 1 is to recognize a component, the higher is the probability of recognizing the correct part number. For this reason, it may be advantageous to keep the solution space as small as possible. For optimized recognition, metaclasses may be programmed which contain special features in order to better recognize similar components.

The user may initially enter the type of engine into the user interface, which reduces the solution space to components that can occur only in the particular type of engine entered. Algorithms that are specifically applied to this type of component, which is recognized beforehand, are provided in a metaclass. Here the AI focuses, for example, between different lengths of screws or different thicknesses of washers. For informing the user, the suggested part number of the component together with the ascertainment of the probability of success and its belonging to a referenced parts list is then represented as a result in the user interface.

Thus far, approaches exist for classifying components based on optical character recognition (OCR), conventional image processing, or machine vision. OCR functions very poorly for metallic components and soiled components. Machine vision and conventional image processing are preferred approaches for very different components for a small solution space.

The number of component classes is too large, and the differences between engine components is too small, to distinguish them only using the above-mentioned technologies. In addition, soiling and wear of the components make the detection more difficult.

The methods for machine learning in the field of classification of objects are known. The combination of optical data and weight data for recognizing components that are very similar visually is novel.

Component classification device 1 may make it possible to automate some processes in the engine disassembly (bulk material kitting, for example). It could be possible for a detection of the components to take place quickly and reliably without human intervention.

The components may be detected, based on their geometry, via machine vision and conventional image processing with the aid of machine learning. The image recording takes place using multiple cameras. At the same time, the weight of the component is detected with the aid of a weight sensor below the storage surface. The collected data are processed by the trained machine learning model and compared to the learned components of the given type of engine, and a classification is automatically made. The system designed in this way learns via the feedback from personnel, and in a short period of time is able to detect new component numbers by retraining of the system.

Component classification device 1 may be used to recognize part numbers of the component, and in one specific embodiment of the component classification device, serial numbers may be additionally recognized. A qualified diagnosis of the components must take place in preceding or subsequent processes, since damage cannot be recognized by the component classification device. Due to their dimensions, housings 2 of component classification device 1 that are constructed for the present machine vision process can recognize only components having a maximum size of 80 mm×80 mm×50 mm. The maximum component weight is limited to 10 kg.

Component classification device 1 recognizes components with a probability of up to 98% when the component has been trained approximately 4-5 times. The user should ideally train the same component 4-5 times (i.e., different individuals/entities). The performance may also change due to the new hardware design and a changed classification in the machine learning algorithm.

In the disassembly of engine parts, the individual parts must be detected in a digital system. This is presently implemented by manually reading out component numbers by personnel and a subsequent manual transfer. In the past, efforts have been made to identify the component numbers by character recognition on the components. However, due to the generally poor legibility and sometimes high degree of soiling, this has not been possible with satisfactory accuracy. To reduce the manual labor and the error rate, this component recognition is to be semi-automated or fully automated.

In the future, the components are to be automatically recognized by the camera device and further sensor systems. If further sensors are necessary in addition to a camera device, which may optionally also include multiple cameras, for reliable recognition of the component, these will be incorporated into the decision-making.

The user may confirm the decision, or if there is uncertainty, may select the correct class from up to three component classes. This allows automatic improvement of the trained model, which also takes place regularly, since new data points are continuously generated. The components may be roughly subdivided according to the three dimensions “component state: new/old,” “geometry: identical, similar, different,” and “component number: present/not present.”

The obtained data set may include camera and sensor recordings of individual components and of the associated component class.

Based on this component spectrum, the accuracy of the developed system may be evaluated based on the accuracy (percentage of the predictions for which the actual component class is in the predicted class or in the three most likely component classes). In addition, a technically simple option may be implemented to integrate new part numbers (components) into the system.

The classification may take place based on deep learning. In particular transfer learning may be applied, since the data set is made up of only a few hundred images. In the transfer learning, a neural network that is trained on a much larger data set is used as the basis. The last “layers” are then cropped from the neural network and replaced by new layers, which are then trained on the actual data set. The validated hypothesis is that in particular the first layers of a neural network are relevant for the feature extraction, for example the edge filtering and corner filtering. Thus, the last remaining layer of the pretrained network then contains a high-dimensional (usually 512-dimensional) representation of abstract pieces of information concerning the underlying image. It is thus necessary only to learn to predict the component classes from this already preprocessed image information. Compared to an image made up of several hundred thousand or millions of pixels, this preprocessing greatly reduces the complexity, and is thus more resource-saving by several orders of magnitude compared to naive approaches. The training may thus be carried out on an arbitrary terminal such as a laptop. This is relevant in particular for the self-learning component of the model to be developed, so that unnecessarily expensive or complicated hardware is not necessary.

The component classification device may distinguish among a very large number of component classes (potentially more than ten thousand items). For this run, this set is reduced to a fraction (fewer than five hundred). For example, hierarchical classifications are suitable for this purpose. A decision tree may be run through in order to determine the correct component class, instead of distinguishing between thousands of components with a single measurement. It is advantageous here that different criteria, methods, and models may be used, depending on the level in the decision tree. At least one two-level classification appears meaningful, since neural networks with such extremely high dimensions (one dimension per possible class, i.e., more than ten thousand) may experience problems. The additional sensor data may be used in the presorting or for the resolution of uncertainties in the prediction.

In conclusion, personnel may always make the final decision, for which reason a user interface may be provided. The following are possible approaches for automatically generating such a decision tree when adding new component classes: based on present metadata, i.e., generating hierarchical pieces of information by assignment in object groups; by presorting the object properties, for example weight or other properties; mapping a classification in the model without the actual target class; and accepting the predominant object group of the predicted component classes for the object which was previously unknown to the system. Based on this generated tree, the parameters of the underlying models and decision threshold values may then likewise be automatedly retrained/established. It may even be possible to modify a small portion of the overall model, which is intended to greatly reduce the computing effort. To ensure the quality of the model, for example a form of regression testing may be used in which a predefined test data set is generated, on which the initial model achieves a certain accuracy. When a model is automatically generated, this new version is evaluated on the same test data set, and is accepted only when the model quality is at least as good as that of the predecessor.

The program code may be developed in Python, for example, due to the wide availability of helpful frameworks and libraries in the field of artificial intelligence and computer vision. The model, which may be formed by the second neural network, for example, in principle may be enhanced and expanded in two ways: (manual) addition of new component classes. This may optimally be made possible via the user interface so that a user him/herself may add new component classes. Data points for the new component class could then be automatedly recorded, manually per input or by sensor/camera measurements. Secondly, (automated) further learning of the model: the user interface may fulfill two objectives: on the one hand, it facilitates the validation of the image analysis by the user for the input into the target system, and on the other hand it allows the continuous generation of training data. Accordingly, the system may be regularly retrained (automatically or manually triggered). The quality assurance is important, in that it is checked (using the above-mentioned regression testing, for example) whether the new model is at least as good as the previous version.

### LIST OF REFERENCE NUMERALS

1 component classification device
2 housing
3 component
4 weighing device
5 weight data
6 camera device
7 image data
8 camera
9 storage surface
10 position
11 lighting device
12 evaluation device
13 image features
14 bottleneck features
15 classification unit
16 component class
17 probability values
18 user interface
19 assessment data
20 image
21 image
22 image
23 first neural network
24 layer of the first neural network
bottleneck layer
S1 through S12 method steps

1-11. (canceled)

12: A component classification device for classifying components into predetermined component classes, the component classification device comprising:
a camera configured to generate image data of a component to be classified;
a weight scale configured to generate weight data of the component to be classified;
an evaluator configured to generate predefined image features from the image data according to a predefined image feature extraction method, and to supply the image data to a pretrained first neural network, and to generate bottleneck features of the image data from a predefined bottleneck layer of the first neural network;
a classifier configured to assign at least one of multiple predefined component classes, the predefined component classes describing predetermined component groups or components, to the component according to a predetermined classification method, based on the weight data, the image features, and the bottleneck features.

13: The component classification device as recited in claim 12 wherein the predetermined classification method includes an assignment to the predetermined component classes by a second neural network.

14: The component classification device as recited in claim 13 wherein the classification unit is configured to ascertain in the predetermined classification method a particular probability value of the at least one predetermined component class describing with what probability the component is assigned to the predetermined component classes.

15: The component classification device as recited in claim 12 wherein the component classification device includes a user interface, the component classification device being configured to output the at least one assigned, predetermined component class to the user interface.

16: The component classification device as recited in claim 15 wherein the predetermined classification method includes an assignment to the predetermined component classes by a second neural network and the component classification device is configured to receive at the user interface predetermined assessment data with regard to the at least one component class or a manually specified component class, the component classification device being configured to adapt the second neural network, as a function of the assessment data, with regard to the component class or the manually specified component class.

17: The component classification device as recited in claim 12 wherein the component classification device is configured to extend a set of the image data using a predetermined data augmentation method.

18: The component classification device as recited in claim 12 wherein the component classification device is configured to generate the image features using a machine vision method.

19: The component classification device as recited in claim 12 wherein the predetermined classification method includes a random forest method.

20: The component classification device as recited in claim 13 wherein the second neural network has a feedforward neural net architecture.

21: A method for classifying a component using a component classification device, the method comprising:
generating, via a camera device of the component classification device, image data of a component to be classified;
generating, via a weight scale of the component classification device, weight data of the component to be classified;
generating, via an evaluator of the component classification device, predetermined image features from the image data according to a predetermined image feature extraction method; and
supplying, via the evaluator of the component classification device, the image data to a pretrained first neural network, and generating bottleneck features of the image data from a predetermined bottleneck layer of the first neural network; and
assigning, via a classifier of the component classification device, to the component to be classified at least one of multiple predefined component classes describing predetermined component groups or components, based on the weight data, the image features, and the bottleneck features, according to a predetermined classification method.

22: A method for training a component classification device (1), the method comprising:
generating, via a camera device of the component classification device, image data of a component to be classified;
generating, via a weight scale of the component classification device, weight data of the component to be classified;
generating, via an evaluator of the component classification device, predetermined image features from the image data according to a predetermined image feature extraction method; and
supplying, via the evaluator of the component classification device, the image data to a pretrained first neural network, and generating bottleneck features of the image data from a predetermined bottleneck layer of the first neural network;
assigning, via a classifier of the component classification device, to the component to be classified at least one of multiple predefined component classes describing predetermined component groups or components, based on the weight data, the image features, and the bottleneck features, according to a predetermined classification method;
receiving at a user interface of the component classification device assessment data or a manually specified component class; and
adapting via the classifier the predetermined classification method according to a predetermined adaptation method in order to assign the manually specified component class to the weight data, the image features, and the bottleneck features.
